(19) United States
(12) Patent Application Publication
(10) Pub. No.: US 2024/0251831 A1
(43) Pub. Date: Aug. 1, 2024

(54) ORGANIC PREBIOTIC CARBOHYDRATE INGREDIENTS FOR FOOD AND BEVERAGE APPLICATIONS

(71) Applicant: CLEMSON UNIVERSITY RESEARCH FOUNDATION, Clemson, SC (US)

(72) Inventors: Pushparajah Thavarajah, Pendleton, SC (US); Dilrukshi Thavarajah, Pendleton, SC (US)

(21) Appl. No.: 18/424,285

(22) Filed: Jan. 26, 2024

Related U.S. Application Data
(60) Provisional application No. 63/481,907, filed on Jan. 27, 2023.

(51) Int. Cl. A23L 11/30; A23L 11/00; A23L 33/00; A23L 33/21

(52) U.S. Cl. CPC A23L 11/33; A23L 11/05; A23L 11/31; A23L 33/21; A23L 33/40

(57) ABSTRACT

Provided are methods of isolating prebiotic carbohydrates and compositions thereof. The methods provide for high concentrations of non-digestible prebiotic carbohydrate. The methods may include a number of processing steps, including heat treating, isolating water-soluble prebiotic carbohydrates, removing protein, and further isolating non-digestible starch-free prebiotic carbohydrates using enzymes.

### CROSS-REFERENCE TO RELATED APPLICATIONS

This application claims priority to and is related to U.S. Provisional Application Ser. No. 63/481,907 filed on Jan. 27, 2023, and entitled “Organic Prebiotic Carbohydrate Ingredients for Food and Beverage Applications,” of which the contents of this patent application are hereby expressly incorporated by reference in its entirety.

### TECHNICAL FIELD

The various embodiments herein relate to carbohydrates for food, beverage, and animal feed applications, and more specifically to organic prebiotic carbohydrate ingredients, including methods of isolating and enriching certain organic prebiotic carbohydrates that result in solid prebiotic carbohydrate extracts and isolates.

### BACKGROUND

Carbohydrates are the most abundant biomolecule, a significant component of plant and animal-based foods, and an energy source for all living forms. Carbohydrates have different chemical and physical structures, and depending on the structure and sizes, carbohydrates provide diverse structural, energy, and physiological roles to living bodies. Carbohydrates are comprised of carbon (C), hydrogen (H), and oxygen (O), and these atoms, in combination, produce simple sugars to complex polymers such as starch and cellulose. With regard to human health, sugars such as glucose, fructose, and sucrose are concerned with elevating blood sugar levels leading to diabetes and heart diseases. However, not all carbohydrates cause a concern to human health. Many low- and nondigestible carbohydrates provide numerous benefits to human health, such as modulating healthy gut bacteria, and combatting obesity and overweight-related non-combinable diseases. Prebiotic or low- and non-digestible carbohydrates are essential for maintaining blood sugar levels, maintaining digestive system-colon health, preventing certain cancers, and promoting health-promoting bacteria in the lower intestine.

Prebiotic carbohydrates have been defined as a selectively fermented ingredient that allows specific changes, both in the composition and/or activity in the gastrointestinal microflora that confers benefits upon host well-being and health. A three-pronged criterion used to classify a compound as a prebiotic include food ingredients that are (1) resistant to mammalian digestion, (2) fermented by intestinal microflora, and (3) stimulate growth selectively and activity of intestinal bacteria associated with health and wellbeing. Therefore, there remains a need in the art for processes of isolating and enriching prebiotic carbohydrates from pulse crops.

### SUMMARY

In Example 1, a method of isolating prebiotic carbohydrates comprises providing a starting material comprising a crop or source of carbohydrate and combining the starting material with water to create a first slurry; and separating the first slurry into a first precipitate and a first supernatant component, wherein the first supernatant component provides a source of water-soluble prebiotic carbohydrates.
Example 2 relates to the method according to Example 1, wherein the crop or source of carbohydrate comprises pulse crops, legumes, cereals, tubers, vegetables, fruits, plants, or a combination thereof.
Example 3 relates to the method according to Example 1 or 2, wherein the crop or source of carbohydrate comprises lentil, chickpea, field pea, cowpea, pigeon pea, faba bean, mung bean, dry bean, soybean, sugar beet, corn, or a combination thereof.
Example 4 relates to the method according to any one of Examples 1 to 3, wherein the starting material is converted to a powder having a particle size between 0.1 nm and 1 μm via a process of dry milling, wet milling, sonication, or a combination thereof, and wherein the starting material is optionally heated prior to being converted to the powder.
Example 5 relates to the method according to any one of Examples 1 to 4, wherein the crop or source of carbohydrate is provided as a powder prior to combining with the water, and wherein the ratio of powdered crop or source of carbohydrate to water is in a range of between about 1:2 to about 1:150 (w/w).
Example 6 relates to the method according to any one of Examples 1 to 5, wherein the slurry is soaked and stirred for a period of between about 30 minutes and 30 hours prior to the separating step.
Example 7 relates to the method according to any one of Examples 1 to 6, wherein the separating step further comprises a step of centrifuging the slurry at a rate of between about 500 rpm and 10,000 rpm for a period of time ranging from between about 1 minute and about 1 hour.
Example 8 relates to the method according to any one of Examples 1 to 7, wherein the supernatant comprises between about 0.1% and about 20% (w/w) of the water-soluble prebiotic carbohydrates.
Example 9 relates to the method according to any one of Examples 1 to 8, further comprising a step of removing protein comprising combining the first precipitate with water at a ratio of between about 1:10 to about 1:100 to form a second slurry; adjusting the pH of the second slurry to a range of between about 7 and about 12; and separating the second slurry into a second precipitate and a second supernatant component, wherein the second supernatant component contains the protein to be removed.
Example 10 relates to the method according to Example 9, wherein the second precipitate provides a source of prebiotic carbohydrates comprising resistant starch, cellulose, other polysaccharides, or a combination thereof.
Example 11 relates to the method according to any one of Examples 9 or 10, wherein the second precipitate comprises between about 10% and 50% or more prebiotic carbohydrates than the starting material.
Example 12 relates to the method according to any one of Examples 9 to 11, wherein the method further isolates non-digestible starch-free prebiotic carbohydrates comprising combining the second precipitate with water at a ratio of between about 1:10 to 1:100 to form a third slurry; adding an enzyme; separating the third slurry into a third precipitate and a third supernatant component, wherein the third precipitate comprises the non-digestible starch-free prebiotic carbohydrates.
Example 13 relates to the method according to Example 12, wherein the enzyme comprises alpha-amylase, other amylases, amyloglucosidase, or a combination thereof and is present in an amount of between about 1 unit and about 40 units per mL.
Example 14 relates to the method according to Example 12 or 13, wherein the third slurry and enzyme are stirred for a period of time ranging between about 30 minutes and about 36 hours prior to separating.
Example 15 relates to the method according to any one of Examples 12 to 14, wherein the third precipitate is washed with water and ethanol at least one time.
Example 16 relates to the method according to any one of Examples 12 to 15, wherein the third precipitate comprises between about 30% to about 90% (w/w) of non-digestible starch-free prebiotic carbohydrates.
In Example 17, a method of isolating prebiotic carbohydrates comprises providing a starting material comprising a crop or source of carbohydrate and combining the starting material with water at a ratio of between about 1:10 to about 1:50 (w/v) to create a slurry; adjusting the pH of the slurry to a range of between about 7 and about 14; and separating the slurry into a precipitate and a supernatant component, wherein the supernatant component comprises protein, and wherein the precipitate comprises the prebiotic carbohydrates.
Example 18 relates to the method according to Example 17, wherein the method results in a concentration of prebiotic carbohydrates in an amount of between about 40% to about 98% by weight.
Example 19 relates to the method according to Example 17 or 18, wherein the method results in a concentration of prebiotic carbohydrates in an amount greater than about 90% by weight.
In Example 20, a method of removing protein comprises providing a starting material comprising a crop or source of carbohydrate, wherein the crop or source of carbohydrate is substantially free of water-soluble prebiotic carbohydrates; combining the starting material with water at a ratio of between about 1:10 to about 1:100 to form a slurry; adjusting the pH of the slurry to a range of between about 7 and about 12; and separating the slurry into a precipitate and a supernatant component, wherein the supernatant component contains the protein to be removed.
Example 21 relates to the method according to Example 20, wherein the precipitate provides a source of prebiotic carbohydrates comprising resistant starch, cellulose, other polysaccharides, or a combination thereof.
Example 22 relates to the method according to Example 20 or 21, wherein the precipitate comprises between about 10% and 50% or more prebiotic carbohydrates than the starting material.
In Example 23 a method of isolating non-digestible starch-free prebiotic carbohydrates comprises providing a starting material comprising a crop or source of carbohydrate, wherein the crop or source of carbohydrate is substantially free of water-soluble prebiotic carbohydrates and protein; combining the starting material with water at a ratio of between about 1:10 to 1:100 to form a slurry; adding an enzyme; separating the slurry into a precipitate and a supernatant component, wherein the precipitate comprises the non-digestible starch-free prebiotic carbohydrates.
Example 24 relates to the method according to Example 23, wherein the enzyme comprises alpha-amylase, other amylases, amyloglucosidase, or a combination thereof and is present in an amount of between about 1 unit and about 40 units per mL.
Example 25 relates to the method according to Example 23 or 24, wherein the slurry and enzyme are stirred for a period of time ranging between about 30 minutes and about 36 hours prior to separating.
Example 26 relates to the method according to any one of Examples 23 to 25, wherein the precipitate is washed with water and ethanol at least one time.
Example 27 relates to the method according to any one of Examples 23 to 26, wherein the precipitate comprises between about 30% to about 90% of non-digestible starch-free prebiotic carbohydrates.
In Example 28, a prebiotic carbohydrate composition comprises non-digestible prebiotic carbohydrate in an amount greater than 90% by weight.
Example 29 relates to the composition of Example 28, wherein the composition further comprises an additional functional ingredient comprising water, vitamins, proteins, fats, or a combination thereof.

While multiple embodiments are disclosed, still other embodiments of the present disclosure will become apparent to those skilled in the art from the following detailed description, which shows and describes illustrative embodiments of the disclosure. Accordingly, the figures and detailed description are to be regarded as illustrative in nature and not restrictive.

### BRIEF DESCRIPTION OF DRAWINGS

FIG. 1 shows water soluble prebiotic carbohydrates from chickpea, lentil, and field pea, according to one implementation.

FIG. 2 is a flow diagram of a method of extracting water-soluble prebiotic carbohydrate, according to one implementation.

FIG. 3 shows resistant starch and cellulose-rich prebiotic carbohydrates from chickpea, lentil, and field pea, according to one implementation.

FIG. 4 shows a flow diagram of a method for extracting resistant starch and cellulose-rich prebiotic carbohydrate, according to one implementation.

FIG. 5 shows non-digestible starch-free prebiotic carbohydrates from chickpea, lentil, and field pea, according to one implementation.

FIG. 6 shows a flow diagram of a method for non-digestible starch-free prebiotic carbohydrate preparations, according to one implementation.

FIG. 7 shows a protein-free prebiotic carbohydrate form chickpea, according to one implementation.

FIG. 8 shows a flow diagram of a method of preparing protein-free prebiotic carbohydrates, according to one implementation.

FIG. 9 shows a flow diagram of a method of milling a raw material for direct application to a food, beverage, and/or feed, according to one implementation.

Various embodiments of the present disclosure will be described in detail with reference to the figures. Reference to various embodiments does not limit the scope of the disclosure. Figures represented herein are not limitations to the various embodiments according to the disclosure and are presented for exemplary illustration of the disclosure.

### DETAILED DESCRIPTION

So that the present disclosure may be more readily understood, certain terms are first defined. Unless defined otherwise, all technical and scientific terms used herein have the same meaning as commonly understood by one of ordinary skill in the art to which embodiments of the disclosure pertain. The embodiments of this disclosure are not limited to particular prebiotic compositions or processes of isolating or enriching prebiotic carbohydrates from any source of carbohydrate, which can vary and are understood by skilled artisans. It is further to be understood that all terminology used herein is for the purpose of describing particular embodiments only and is not intended to be limiting in any manner or scope.

The term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, or up to 10%, or up to 5%, or up to 1% of a given value. Alternatively, particularly with respect to biological systems or processes, the term can mean within an order of magnitude, or within 5-fold, or within 2-fold, of a value.

As used herein, a “prebiotic” refers to an ingredient that allows specific changes, both in the composition and/or activity in the gastrointestinal microbiota that may (or may not) confer benefits upon the host. In some embodiments, a prebiotic can be a comestible food or beverage or ingredient thereof. In some embodiments, a prebiotic may be a selectively fermented ingredient. Prebiotics may include, but are not limited to, complex carbohydrates, amino acids, peptides, minerals, other essential nutritional components, or combinations thereof.

As used herein, the term “substantially free” refers to compositions completely lacking the component or having a small amount of the component that the component does not affect the performance of the composition. The component may be present as an impurity or as a contaminant and/or is present at an amount of less than about 0.5% by weight. In another embodiment, the amount of the component is less than about 0.1% by weight and in yet another embodiment, the amount of component is less than about 0.01% by weight.

The term “weight percent,” “wt. %,” “wt-%,” “percent by weight,” “% by weight,” and variations thereof, as used herein, refer to the concentration of a substance as the weight of that substance divided by the total weight of the composition and multiplied by 100.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range.

Disclosed and contemplated herein are methods for isolating prebiotic carbohydrates from a carbohydrate source and creating organic prebiotic carbohydrate compositions resulting therefrom. Various carbohydrate sources may be contemplated, including, but not limited to crops. In embodiments, the crops may include pulse crops, legumes, cereals, tubers, vegetables, fruits, and plants. Pulses are a rich source of prebiotic carbohydrates, and in certain implementations, depending on the type of pulse and variety, prebiotic carbohydrate concentrations may be 50% or more. In embodiments, the methods and processes contemplated herein provide for isolating and enriching various prebiotic carbohydrate ingredients from pulse crops for 100% USDA (United States Department of Agriculture) organic-certified applications.

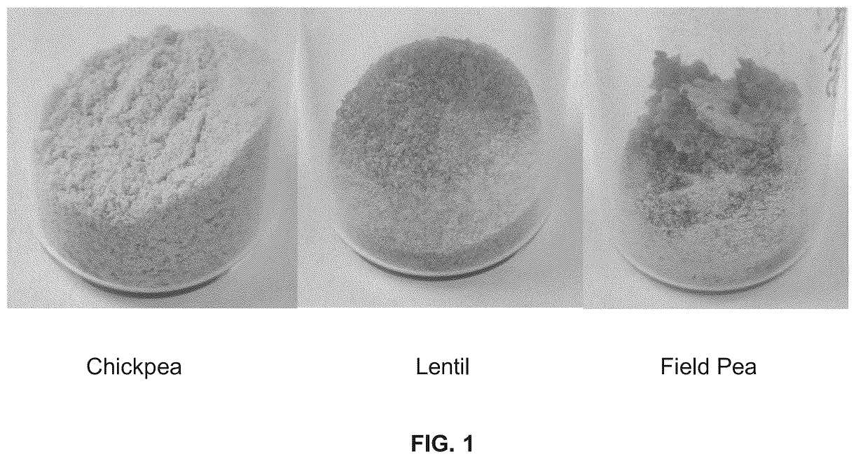

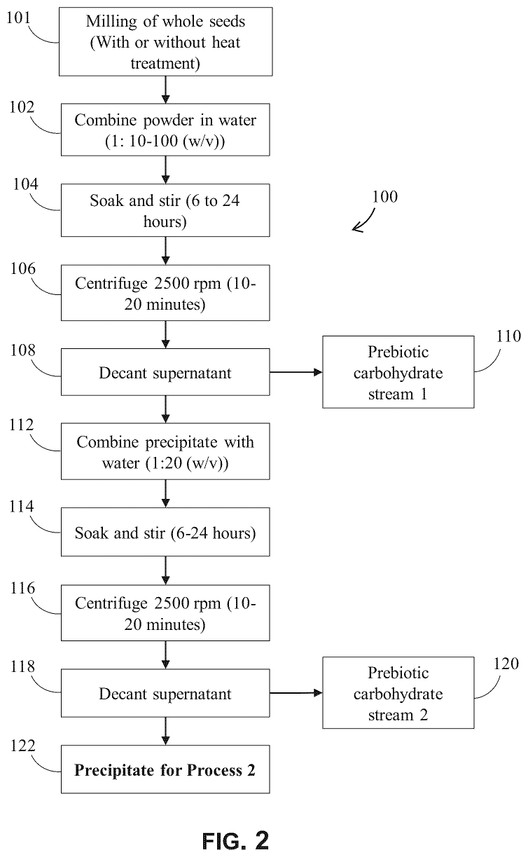

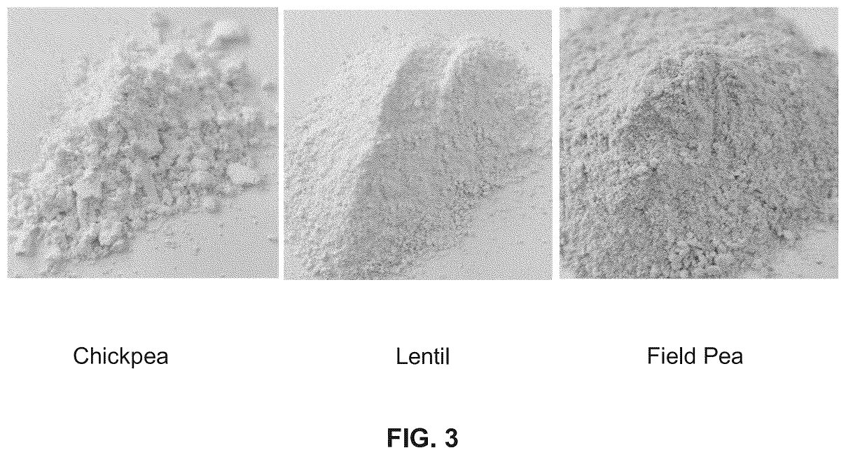

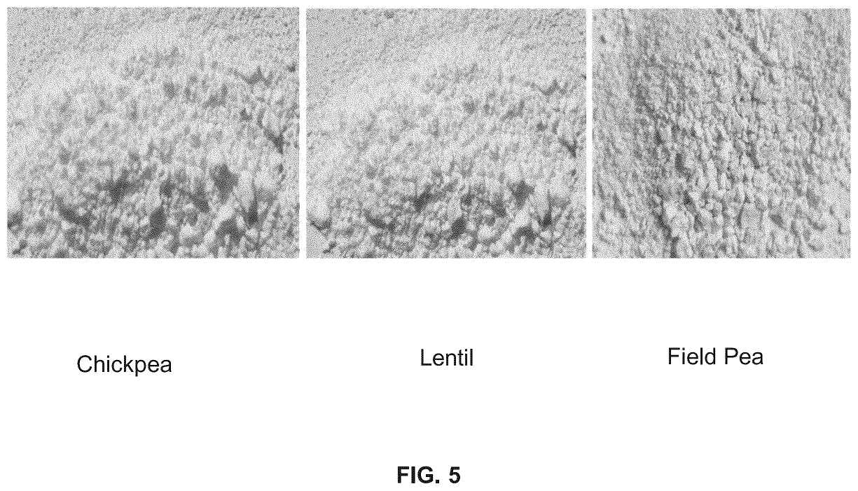

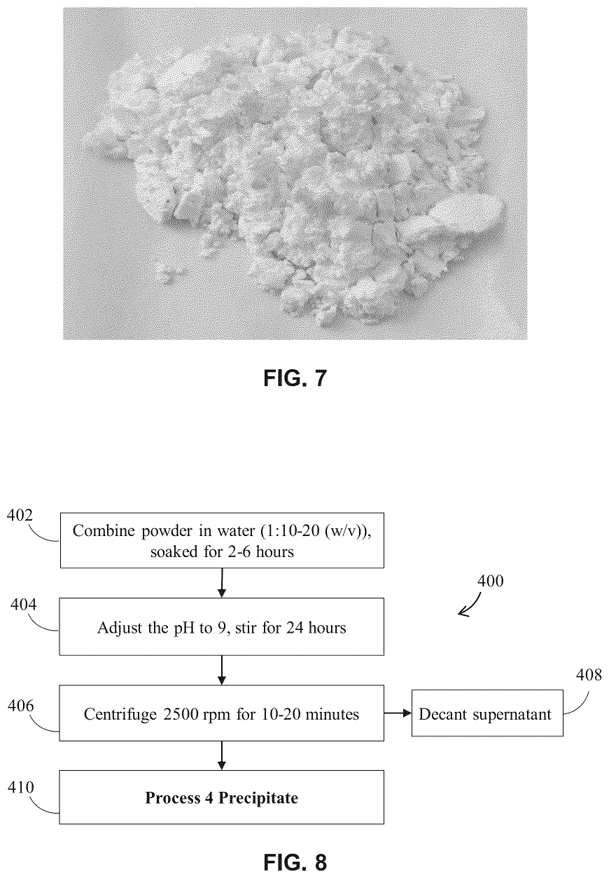

In various embodiments, the methods described herein may yield either dry, semi-solid, or liquid carbohydrate compositions. FIG. 1, FIG. 2, FIG. 3, FIG. 5, and FIG. 7 show various pulse compositions from the disclosed methods. In various implementations, while the compositions of FIGS. 1, 2, 3 5, and 7 are dry compositions, the various carbohydrate compositions can be used in solid, liquid, and semi-solid foodstuffs.

Disclosed herein are exemplary isolation processes for producing the organic prebiotic carbohydrate compositions. The specific methods discussed in detail below can be used to isolate prebiotic carbohydrates from any known crops or sources of carbohydrates, including, but not limited to, sources that are chemically modified. In some aspects, the prebiotic carbohydrates are isolated from any known pulse crop, including, but not limited to, chickpea, lentil, and field pea, for example. It is further understood that other known prebiotic carbohydrates can be isolated using the methods disclosed or contemplated herein, including, but not limited to, carbohydrates from other pulses, legumes, cereals, tubers, vegetables, fruits, and plants, for example. Some non-limiting examples of such additional plants that can be used as the raw materials include lentil, chickpea, field pea, cowpea, pigeon pea, faba bean, mung bean, dry bean, soybean, oats, nuts, sugar beet, corn, and other protein rich plants.

According to certain embodiments, the raw material (crop or source of carbohydrates) is a plant protein source. In some aspects, the plant protein source is the seed. For example, the plant material that serves as the raw material is the seed. However, it is understood that other plant parts—such as, for example, the stalk, leaf, root or other part—can serve as the starting plant material.

It is understood that, with respect to the methods described herein, according to certain embodiments, the raw material (crop or other source of carbohydrate) should be in a powder form prior to processing. Thus, as an initial matter, if not already in powder form, the plant product is ground or milled into a fine powder. For example, in one implementation in which the plant product is present in whole seed form, the seeds may be ground into a fine powder using a known grinding apparatus such as a mill to produce a powdered pulse flour. Similarly, a plant product can be ground into a powder in a similar fashion. In embodiments, the particle size reduction of the raw material may be carried out in a variety of methods. In some aspects, the particle size of the raw material is reduced by wet milling, dry milling, sonication, or a combination thereof.

In some embodiments, the raw materials or whole seeds may optionally be subject to a heat treatment prior to milling. In some embodiments, the heat treatment may comprise boiling, roasting, or any other form of heating. While the present disclosure is not limited to any particular mechanism of action or theory, it is contemplated that, in some embodiments, raw materials and seeds high in fat may be spoiled by rancidity due to fatty acid oxidizing enzymes. In some aspects, the fatty acid oxidizing enzymes may include, but are not limited to, lipoxygenase enzymes, and other oxidase enzymes. Therefore, in some aspects, the heat treatment may by applied to prevent lipoxygenase enzyme activity and preserve the fatty acids within the composition. In some aspects, the overall powder (or flour) product quality resulting from the milling step may be improved due to the heat treatment. For example, the heat treatment may enhance prebiotic carbohydrates in the resulting powder or flour product post-milling, as well as reduce rancidity.

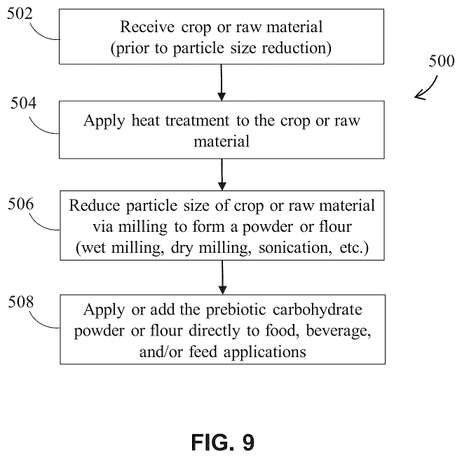

In some aspects, pulse crops are particularly rich in prebiotic carbohydrates. For example, pulse crops such as chickpeas, may contain up to 50% prebiotic carbohydrates. In further aspects, crops such as, but not limited to, chicory and artichokes are further examples of materials high in prebiotic carbohydrates. In some aspects, the raw materials or crops of the disclosure may be milled into a fine powder, flour, or slurry for use directly in or added to food and/or beverages. Beneficially, milling crops rich in prebiotic carbohydrates for use in or added directly to food and/or beverages can save time and cost while providing the food and/or beverage with a source of prebiotic carbohydrates. An example embodiment of the process for milling a raw material or crop for direct application is shown in FIG. 9.

In further aspects, the raw materials or crops of the disclosure including, but not limited to, soybean, oats, corn, nuts (including, for example, peanuts), and other oil seeds, are suitable for providing a source of prebiotic carbohydrates and dietary fibers. In some embodiments, the raw materials or crops have high oil content. In embodiments, the oil from the raw materials or crops may be extracted resulting in meal or flour, such as, for example, soybean meal, which may be used as a source of prebiotic carbohydrates and dietary fiber. In further embodiments, certain plants may be used as a source of dietary fibers after sugar/sucrose extraction. For example, sugar beets may provide a source of dietary fiber after sucrose extraction as sugar beet meal. Further, distillers dried grain or other material left after bioethanol production may further provide a source of dietary fiber and prebiotic carbohydrates. In embodiments, the raw materials or crops, including the whole seeds, leaves, stems, or by products thereof, may be wet or dry powdered to be directly incorporated into or added to food, beverage, and/or feed applications to increase fiber content, without further need for any chemical or physical modification. In embodiments, the raw materials or crops may include, but are not limited to, the whole seeds, leaves, stems, or any by products from oil extracted crops (including, but not limited to, soy oil, corn oil, etc.) and sugar extracted crops (including, but not limited to, sugar beets). In further embodiments, the raw materials or crops may include, but are not limited to, the fruits, stems, leaves, and roots of plant crops (including, but not limited to, artichoke, chicory, etc.).

In certain implementations, the raw material or seeds may be ground into a fine powder or slurry having a particle size of less than about 1 μm, less than about 0.5 μm, or less than about 0.1 μm. For example, the particle size may be in the range of about 0.1 nm to about 1000 nm, about 1 nm to about 750 nm, or about 1 nm to about 500 nm. According to some embodiments, the seeds may be ground using a known UD cyclone mill to a particle size at sieve no. 35, although other equipment and processes for grinding are possible as would be appreciated by those of skill in the art. After the grinding and/or milling step is complete, the resultant powder and/or slurry may optionally be cooled to about room temperature prior to further processing as described below.

It is further understood that, with respect to the methods described herein, according to embodiments, the methods provide for the isolation and enrichment of different prebiotic carbohydrate ingredients from crops or other sources of carbohydrates. A prebiotic is a food ingredient that passes the small intestines without being substantially digested, such as a non-digestible oligosaccharide or polysaccharide, and that beneficially affects the host by selectively stimulating the growth and/or activity of one or a limited number of potentially beneficial bacteria in the colon. In various embodiments herein, prebiotic carbohydrates are substances belonging to a class of carbohydrates that cannot be broken down in the upper digestive tract and serve as a selective food source for certain microorganisms in the colon.

In aspects, sugar alcohols, monosaccharides, oligosaccharides, and resistant starches are major prebiotic carbohydrates found in most plant-based foods. In certain aspects, the prebiotic carbohydrate comprises oligofructose, inulin, galacto-oligosaccharides, oligosaccharides from soybeans, isomalto-oligosaccharides, xylo-oligosaccharides, or combinations thereof. In some aspects, prebiotic sugar alcohols may include, but are not limited to, sorbitol and mannitol. In further aspects, prebiotic monosaccharides may include, but are not limited to, rhamnose, xylose, glucose, and fructose. In still further aspects, prebiotic oligosaccharides may include, but are not limited to, raffinose, stachyose, verbascose, kestose, and nystose. In still further aspects, prebiotic polysaccharides include, but are not limited to, resistant starch and cellulose. In some embodiments, the prebiotic carbohydrate may include any carbohydrates that cannot be digested by human digestive enzymes, including physically and chemically entrapped forms of carbohydrates. As would be appreciated by those of skill in the art, additional prebiotic carbohydrates may be further isolated and enriched from pulse crops.

FIG. 2 shows a diagram of a first exemplary process 100 (“Process 1”) for extracting water-soluble carbohydrates, according to one embodiment. In one step as shown in the figure, a powdered crop can be combined with water (box 102) at a ratio of about 1:10 to 1:100 w/v. Alternatively, the ratio can range from about 1:2 to about 1:150 w/v. In various implementations, the water is high purity grade water (≤0.5Ω). Alternatively, the water can be any known form of water from any known source, including, for example, portable water, purified water, water sourced from a city or other local source, or any other type of water suitable for food and beverage applications. For embodiments where whole seed is provided, the whole seed may be first milled to produce a powder (box 101) prior to combining with water. In further embodiments, prior to milling, the whole seed may optionally be heat treated as described within the disclosure.

The powder and water combination is then soaked and stirred (box 104) to form a first slurry. According to certain embodiments, as a part of the “soak and stir” step (box 104), the resulting slurry can be stirred, such as via magnetic, mechanical blade stirrers, mechanical agitation, or other known stirring mechanisms as would be appreciated by those of skill in the art. In various implementations, the first slurry is stirred (box 104) for a period of time ranging between about 1 hour and about 30 hours, between about 1 hour and about 24 hours, or between about 6 hours and about 24 hours. In some embodiments, the first slurry is left for a period of time ranging between about 30 minutes to about 30 hours, between about 1 hour to about 30 hours, or between about 2 hours to about 24 hours. In further embodiments, the first slurry is stirred for a period of time greater than about 30 hours. In aspects, this allows for non-water-soluble solids to precipitate to the bottom.

In a further step, according to some embodiments, the first slurry is further separated into its solid and liquid fractions via a centrifuge (box 106) or via other appreciated device or process to separate solids and liquids. In certain embodiments, the first slurry, or mixture, is centrifuged at a rate of between about 500 rpm and about 10,000 rpm, between about 1000 rpm and about 5,000 rpm, between about 2000 rpm and about 4,000 rpm, or about 2,500 rpm. In further embodiments, the mixture is centrifuged at a rate greater than about 10,000 rpm. In embodiments, the mixture is centrifuged for a period of time ranging from between about 1 minute and about 1 hour, between about 5 minutes and about 45 minutes, or between about 10 minutes to about 20 minutes. In further embodiments, the mixture is centrifuged for a period of time greater than about 1 hour. After centrifugation, the two fractions are separated into a first precipitate and a first supernatant component. For example, in embodiments, the liquid portion, or first supernatant, can be decanted (box 108) to separate the supernatant from the solid fraction, or first precipitate. Alternatively, the two fractions can be separated in any fashion known to those skilled in the art. In optional embodiments, the first supernatant may be dried to remove moisture and milled to a fine powder.

The separated first supernatant provides a first extract of prebiotic carbohydrate or prebiotic carbohydrate stream 1 (box 110). In some embodiments, the decanted solution may have between about 0.1% and about 20% (w/w), between about 0.5% and about 15%, between about 1% and about 10%, or between about 4% and 6% of water-soluble prebiotic carbohydrate. In some aspects, the water-soluble prebiotic carbohydrates may comprise at least one of myo-inositol, xylitol, galactinol, sorbitol, mannitol, rhamnose, arabinose, xylose, glucose, fructose, ribose, sucrose, raffinose, stachyose, verbascose, kestose, maltose, nystose, or a combination thereof.

In accordance with certain embodiments, more than one water extraction of the precipitate residue collected after decanting the supernatant (from box 108) may be completed. In embodiments, a second or more water extraction steps may be implemented to obtain further concentrations of water-soluble prebiotic carbohydrates that may be present in the precipitate residue. In embodiments where a second water extraction is implemented, the precipitate after the first centrifugation and decantation (box 106 and 108) is combined with water (box 112) at a ratio of about 1:10 to 1:50 (w/v), or about 1:20 (w/v). Alternatively, the ratio can range from about 1:2 to about 1:100 (w/v). In various implementations, the water is high purity grade water (<0.5Ω). Alternatively, the water can be any known form of water from any known source, including, for example, portable water, purified water, water sourced from a city or other local source, or any other type of water suitable for food and beverage applications.

The second water extraction then follows the same steps as completed in the first water extraction (box 104 and 114; box 106 and 116; box 108 and box 118). After separating the liquid fraction from the solid fraction (box 118), the separated supernatant provides a second extract of prebiotic carbohydrate or prebiotic carbohydrate stream 2 (box 120). In optional embodiments, the decanted solution may be dried to remove moisture and milled to a fine powder. In certain embodiments, providing a second water extraction may result in an additional about 0.1% to about 10%, or about 0.5% to about 7%, or about 1% to about 3% (w/w) yield of the same water-soluble prebiotic carbohydrates as described in the first water extraction step. In some aspects, the total amount of water soluble carbohydrates that may be extracted after one or more extractions include between about 0.1% and about 20% (w/w), between about 0.5% and about 15% (w/w), or between about 1% and about 10% (w/w) of the starting material. Therefore, as would be appreciated by those skilled in the art, more than one water extractions of the pulse flours may be conducted. In embodiments, at least one water extraction is conducted on the pulse flours. In other embodiments, at least two water extractions are conducted on the pulse flours.

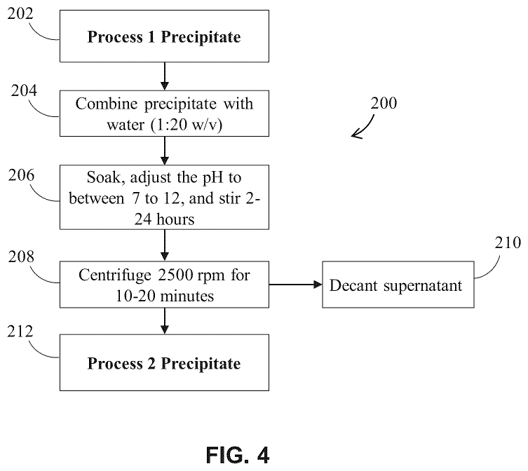

FIG. 4 shows a further process 200 (“Process 2”) for extracting prebiotic carbohydrates, such as resistant starch, cellulose-rich prebiotic carbohydrates, and other polysaccharides according to an embodiment. According to certain embodiments, Process 2 utilizes the precipitate formed at the end of Process 1 (box 202). In embodiments, Process 2 may utilize any starting material or composition that has had water-soluble prebiotic carbohydrates removed. In further embodiments, Process 2 may utilize any starting material or composition that is substantially free of water-soluble prebiotic carbohydrate. In one exemplary step as shown in the figure, the precipitate from Process 1 can be combined with water (box 204) at a ratio of about 1:10 to about 1:100 (w/v), or about 1:20 (w/v) to form a slurry (may also be referred to herein as the “second slurry”). Alternatively, the ratio can range from about 1:2 to about 1:150 (w/v). In various implementations, the water is high purity grade water (<0.5Ω). Alternatively, the water can be any known form of water from any known source, including, for example, portable water, purified water, water sourced from a city or other local source, or any other type of water suitable for food and beverage applications.

In a further step, the powder or precipitate may be soaked in the water to form the second slurry. In embodiments, the pH of the water is adjusted to a range of between about 7 to about 12, between about 8 to about 11, or between about 8 to about 10 (box 206). In some aspects, the pH is adjusted with an alkalinity source. In embodiments, the alkalinity source may include, but is not limited to, an alkali metal hydroxide or alkaline earth metal hydroxide. In further embodiments, the alkalinity source may comprise sodium hydroxide, potassium hydroxide, calcium hydroxide, magnesium hydroxide, bicarbonates or carbonates of those metals, or a combination thereof. According to certain embodiments, the resulting slurry can be stirred, such as via magnetic, mechanical blade stirrers, mechanical agitation, or other known stirring mechanisms as would be appreciated by those of skill in the art (box 206). In various implementations, the second slurry is stirred for a period of time ranging between about 30 minutes and about 30 hours, between about 1 hour and about 24 hours, or between about 2 hours and about 24 hours. The stirring may occur at a temperature of between about 15° C. and 30° C., between about 20° C. and about 25° C., or at about room temperature. In some embodiments, the slurry is left for a period of time to allow for the precipitate and supernatant to settle into two layers.

In a further step, according to some embodiments, the second slurry is further separated into its solid and liquid fractions via a centrifuge (box 208) or via other appreciated device or process to separate solids and liquids. In certain embodiments, the second slurry or mixture is centrifuged at a rate of between about 500 rpm and about 10,000 rpm, between about 1000 rpm and about 5,000 rpm, between about 2000 rpm and about 4,000 rpm, or about 2,500 rpm. In some embodiments, the mixture may be centrifuged at a rate greater than about 2,500 rpm. In embodiments, the mixture is centrifuged for a period of time ranging from between about 1 minute and about 1 hour, between about 5 minutes and about 45 minutes, or between about 10 minutes to about 20 minutes. In some embodiments, the mixture may be centrifuged for a period of time greater than about 1 hour. After centrifugation, the two fractions are separated into a second precipitate and a second supernatant component. For example, in embodiments, the second supernatant, or liquid portion, can be decanted (box 210) to separate the supernatant from the precipitate. Alternatively, the two fractions can be separated in any fashion known to those skilled in the art. In some embodiments, the supernatant provides a source of protein, depending on the type of pulse flour. The resulting solid residue provides a source of prebiotic carbohydrates such as resistant starch (RS), cellulose, other polysaccharides, or a combination thereof (box 212). In some aspects, Process 2 removes and separates the protein through the supernatant, leaving the source of prebiotic carbohydrates in the solid fraction.

The isolated prebiotic carbohydrate in the solid fraction may provide for at least 5% more prebiotic carbohydrates, at least 10% more prebiotic carbohydrates, at least 20% more prebiotic carbohydrates, at least 30% more prebiotic carbohydrates, at least 40% more prebiotic carbohydrates, or at least 50% more prebiotic carbohydrates compared to the percentage of prebiotic carbohydrates in the starting material. In some aspects, the percentage of prebiotic carbohydrates in the starting material may only have up to about 50% prebiotic carbohydrates. In embodiments, Process 2 provides for isolated prebiotic carbohydrates having between about 10 to 50% or more prebiotic carbohydrates. As will be appreciated by those skilled in the art, the percentage increase in prebiotic carbohydrates may vary depending on the pulse type and variety.

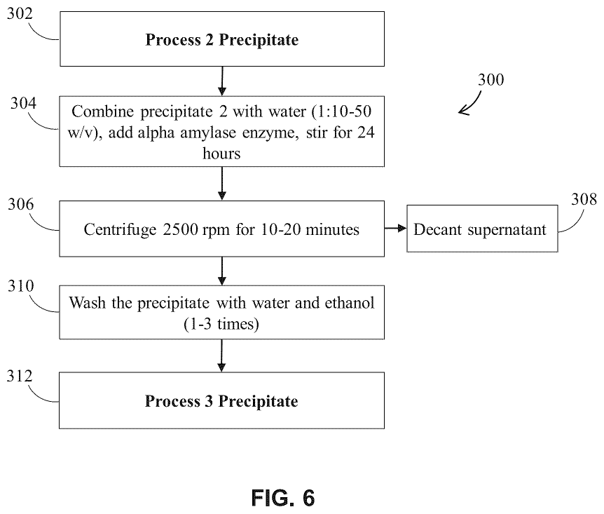

FIG. 6 shows a further process 300 (“Process 3”) for providing non-digestible starch-free prebiotic carbohydrate compositions. According to certain embodiments, Process 3 utilizes the precipitate formed at the end of Process 2 (box 302). In other embodiments, Process 3 may utilize any starting material or composition that has both water-soluble prebiotic carbohydrates and protein removed. In further embodiments, Process 3 may utilize any starting material or composition that is substantially free of water-soluble prebiotic carbohydrate and protein. In one example step as shown in the figure, the precipitate from Process 2 can be combined with water (box 304) at a ratio of about 1:10 to 1:100 (w/v), or about 1:10 to 1:50 (w/v) to form a slurry (which may also be referred to herein as the “third slurry”). Alternatively, the ratio can range from about 1:2 to about 1:150 (w/v). In various implementations, the water is high purity grade water (<0.5Ω). Alternatively, the water can be any known form of water from any known source, including, for example, portable water, purified water, water sourced from a city or other local source, or any other type of water suitable for food and beverage applications.

In a further step, an enzyme may be added to the third slurry. In embodiments, an enzyme that can break glycosidic bonds in readily digestible carbohydrates may be utilized. In further embodiments, the enzyme may include, but is not limited to, alpha-amylase, other amylases, amyloglucosidase enzyme, or a combination thereof. The amount of enzyme added may be in the range of between about 1 to about 40 units per mL, or between about 1 to about 35 units per mL, or between about 5 units to about 30 units per mL. As will be understood by those skilled in the art, similar enzyme ratios are provided for volumes per liter and gallons, and are not limited to milliliters.

According to certain embodiments, the third slurry and enzyme combination can be stirred, such as via shaking, magnetic stirrers, mechanical blade stirrers, mechanical agitation, or other known stirring mechanisms as would be appreciated by those of skill in the art (box 304). In various implementations, the slurry and enzyme are stirred for a period of time ranging between about 30 minutes and about 36 hours, between about 1 hour and about 30 hours, or between about 10 hours and about 24 hours. In some embodiments, the slurry is left for a period of time to allow for complete starch hydrolysis for about 10-20 hours. In certain implementations, upon allowing the enzyme to digest all highly digestible starch, the combination was left to precipitate into solids and supernatant and settle into two layers.

In a further step, according to some embodiments, the third slurry and enzyme combination is further separated into its solid and liquid fractions via a centrifuge (box 306) or via other appreciated device or process to separate solids and liquids. In certain embodiments, the mixture is centrifuged at a rate of between about 500 rpm and about 10,000 rpm, between about 1000 rpm and about 5,000 rpm, between about 2000 rpm and about 4,000 rpm, or about 2,500 rpm. In further embodiments, the mixture is centrifuged at a rate greater than about 2,500 rpm. In embodiments, the mixture is centrifuged for a period of time ranging from between about 1 minute and about 1 hour, between about 5 minutes and about 45 minutes, or between about 10 minutes to about 20 minutes. In further embodiments, the mixture is centrifuged for a period of time greater than about 1 hour. After centrifugation, the two fractions are separated. For example, in embodiments, the liquid portion can be decanted (box 308) to separate the supernatant from the solid fraction. Alternatively, the two fractions can be separated in any fashion known to those skilled in the art.

In further embodiments, the precipitate solids are washed with water and ethanol to remove all glucose resulting from starch. The washing of the precipitate solids may be completed one time or a number of times. In embodiments, the precipitate solids are washed with water and ethanol between one and five times, between one and four times, or between one and three times. The results precipitate may be dried to obtain prebiotic carbohydrates. In some aspects, the prebiotic carbohydrates may comprise resistant starch, non-digestible polysaccharides, and other water-insoluble carbohydrates. In embodiments, Process 3 as described herein may extract between about 30 to 90% of amylose indigestible and/or prebiotic carbohydrates, or between about 50 to 80% of amylose indigestible and/or prebiotic carbohydrates.

FIG. 8 shows an alternative process 400 (“Process 4”) of providing total carbohydrates after extraction of proteins from a pulse flour. In one step as shown in the figure, a powdered pulse flour can be combined with water (box 402) to form a slurry at a ratio of about 1:10 to 1:50 w/v. Alternatively, the ratio can range from about 1:10 to about 1:20 w/v. In various implementations, the water is high purity grade water (≤0.5Ω). Alternatively, the water can be any known form of water from any known source, including, for example, portable water, purified water, water sourced from a city or other local source, or any other type of water suitable for food and beverage applications.

In embodiments, the powder and water combination is then soaked (box 402) to form a slurry. According to certain embodiments, the powdered pulse is soaked in water for a period of time of between about 1 hour and about 10 hours, between about 2 hours and between 9 hours, or between about 2 hours and about 6 hours. In a further step, according to embodiments, the pH of the solution is adjusted to between about 7 and about 14 or between about 8 and about 11. In some aspects, the pH is adjusted with an alkalinity source. In embodiments, the alkalinity source may include, but is not limited to, an alkali metal or alkaline earth metal hydroxide, carbonate, or bicarbonate thereof. In further embodiments, the alkalinity source may comprise sodium hydroxide, potassium hydroxide, calcium hydroxide, magnesium hydroxide, sodium carbonate, potassium carbonate, calcium carbonate, magnesium carbonate, sodium bicarbonate, potassium bicarbonate, calcium bicarbonate, magnesium bicarbonate, or a combination thereof.

In embodiments, the resulting slurry can be stirred, such as via magnetic, mechanical blade stirrers, mechanical agitation, or other known stirring mechanisms as would be appreciated by those of skill in the art. In various implementations, the slurries are stirred (box 104) for a period of time ranging between about 12 hours and about 60 hours, between about 18 hours and about 48 hours, or between about 24 hours and about 48 hours. This time enables the solubilization of the protein in the flour in an alkaline solution.

In a further step, according to some embodiments, the slurry is further separated into its solid and liquid fractions via a centrifuge (box 406) or via other appreciated device or process to separate solids and liquids. In certain embodiments, the mixture is centrifuged at a rate of between about 500 rpm and about 10,000 rpm, between about 1000 rpm and about 5,000 rpm, between about 2000 rpm and about 4,000 rpm, or about 2,500 rpm. In embodiments, the mixture is centrifuged for a period of time ranging from between about 1 minute and about 1 hour, between about 5 minutes and about 45 minutes, or between about 10 minutes to about 20 minutes. After centrifugation, the two fractions are separated. For example, in embodiments, the liquid portion can be decanted (box 408) to separate the supernatant from the solid fraction. In embodiments, two fractions separate into a protein-rich supernatant and a carbohydrate-rich precipitate. Alternatively, the two fractions can be separated in any fashion known to those skilled in the art. In optional embodiments, the precipitate residue may be dried to remove moisture and milled to a fine powder. In embodiments, Process 4 provides for an end product rich in prebiotic carbohydrates. In some embodiments, the prebiotic carbohydrates may range from an amount of between about 40% to about 98%, about 50% and about 95%, or about 60% and about 90% by weight. In further embodiments, the total percentage of prebiotic carbohydrate of the end product may be greater than about 70%, about 80%, or about 90% by weight.

In further aspects, prebiotic carbohydrate compositions are provided. Beneficially, the methods of the disclosure provide for all organic prebiotic carbohydrates. In some aspects, the compositions are certified organic according to the United States Department of Agriculture (USDA). In some aspects, the methods of the disclosure provide for the isolation or enrichment of compositions that comprise substantially pure prebiotic carbohydrate fractions. In further embodiments, the compositions are not chemically-modified. In some embodiments, the prebiotic carbohydrate compositions may be made by the processes described herein. In some aspects, the prebiotic carbohydrate compositions comprise non-digestible prebiotic carbohydrate in an amount greater than about 70%, about 75%, about 80%, about 85%, about 90%, about 95%, or about 98% by weight.

As described throughout the present disclosure, FIG. 9 shows a process 500 of directly providing a prebiotic carbohydrate composition for an application of use, including, but not limited to, a food, beverage, feed, or combination thereof. In one step as shown in the figure, a crop or raw material is obtained or received (box 502). In aspects, the particle size of the crop or raw material has not yet been reduced. A heat treatment is applied to the crop or raw material (box 504) for improving the quality of the final powder or flour composition. Optionally, the crop or raw material is subsequently cooled. In implementations, the particle size of the crop or raw material is reduced via a step of milling (box 506). As described herein, the milling may comprise wet milling, dry milling, sonication, or by other method to reduce the particle size to a powder or flour product. Optionally, the powder or flour product may be further combined with water to form a slurry. The milled powder or flour product may be used without further processing for a variety of uses. In some implementations, the prebiotic carbohydrate powder or flour product may be applied or added directly added to food, beverage, and/or feed applications (box 508).

In further embodiments, the prebiotic carbohydrate compositions may comprise additional functional ingredients. The additional functional ingredients suitable for use with the compositions include any materials that impart beneficial properties to the prebiotic carbohydrate compositions. Examples of suitable additional functional ingredients may include, but are not limited to, water, vitamin, protein, and fat. In some embodiments, the prebiotic carbohydrate compositions are substantially free of protein. In further embodiments, the prebiotic carbohydrate compositions are substantially free of water-soluble prebiotic carbohydrates.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure and can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Water-Soluble Carbohydrate Extraction Process (“Process 1”)

Powdered pulse flour was combined with water at 1:10-100 ratios by weight or volume of water, soaked, and mixed by mechanical agitation for 6-24 hours at room temperature. The resulting slurry was left for 2-24 hours to precipitate non-water-soluble solids to the bottom, and centrifuged at 2500 rpm for 4-10 minutes to separate solids from the supernatant. The supernatant was decanted. The decanted solution had 4 to 6% (w/w) of water-soluble prebiotic carbohydrates, including myo-inositol, xylitol, galactinol, sorbitol, mannitol, rhamnose, arabinose, xylose, glucose, fructose, ribose, sucrose, raffinose, stachyose, verbascose, kestose, maltose, and nystose. The decanted solution was dried to remove moisture and milled to a fine powder. Repeated water extraction of the residue (i.e., precipitate) using the same procedure resulted in another 1-3% (w/w) yield of the same water-soluble prebiotic carbohydrates. Therefore, it may be expected that one to two water extractions of pulse flours may result in 5-10% or more water-soluble prebiotic carbohydrates. FIG. 1 shows the water-soluble prebiotic carbohydrates from chickpea, lentil, and field pea protein from Example 1.

Water-soluble carbohydrate compositions are further provided in Table 2 and Table 3. Table 2 shows water-soluble prebiotic carbohydrates, their concentrations, and extractions with one water extraction. Table 3 shows water-soluble prebiotic carbohydrates, their concentrations, and extractions with two water extractions. Abbreviations provided within the tables are further provided below in Table 1. The process of Example 1 is reflected in FIG. 2 showing the diagram of a first exemplary process 100.

TABLE 1
Abbreviations

| | |
|---|---|
| GP1 | Green pea sample 1 |
| GP2 | Green pea sample 2 |
| GP3 | Green pea sample 3 |
| GP4 | Green pea sample 4 |
| RL1 | Red lentil sample 1 |
| RL2 | Red lentil sample 2 |
| RL3 | Red lentil sample 3 |
| RL4 | Red lentil sample 4 |
| CP1 | Chickpea sample 1 |
| CP2 | Chickpea sample 2 |
| CP3 | Chickpea sample 3 |
| CP4 | Chickpea sample 4 |
| GP1.2 to GP4.2 | Second washes of the same samples to extract any |
| RL1.2 to RL4.2 | remaining water-soluble prebiotic carbohydrates |
| CP1.2 to CP4.2 | |
| Myo | Myoinositol |
| Xy | Xylitol |
| Gal | Galactinol |
| Sor | Sorbitol |
| Man | Mannose |
| Rha | Ramnose |
| Ara | Arabinose |
| Xyl | Xylose |
| Glu | Glucose |
| Fru | Fructose |
| Rib | Ribose |
| Suc | Sucrose |
| Raf + Sta | Raffinose and stachyose |
| Ver + Kes | Verbascose and kestose |
| Mal | Maltose |
| Nys | Nystose |

TABLE 2

| | Prebiotic carbohydrate Concentration in solution after washing mg/100 g | | | | | | | | | | | | | | | | |
|---|---|---|---|---|---|---|---|---|---|---|---|---|---|---|---|---|---|
| | | | | | | | | | | | | | Raf + | Ver + | | | Total |
| Method | Myo | Xy | Gal | Sor | Man | Rha | Ara | Xyl | Glu | Fru | Rib | Suc | Sta | Kes | Mal | Nys | (g/100 g) |
| GP 1 | 161.2 | 8.0 | 68.7 | 24.6 | 3.9 | 12.9 | 11.9 | 14.9 | 58.3 | 8.1 | 20.3 | 2150.9 | 1470.4 | 1298.4 | 45.9 | 1.3 | 5.4 |
| GP 2 | 149.5 | 7.0 | 66.5 | 23.6 | 3.8 | 13.5 | 12.5 | 15.5 | 50.0 | 8.0 | 19.5 | 2068.8 | 1394.5 | 1230.0 | 47.9 | 1.0 | 5.1 |
| GP 3 | 85.6 | 0.4 | 35.9 | 25.6 | 2.0 | 11.9 | 10.2 | 14.8 | 49.7 | 4.7 | 18.5 | 1955.0 | 1453.9 | 1205.5 | 31.9 | 0.9 | 4.9 |
| GP 4 | 90.8 | 0.3 | 36.4 | 26.6 | 2.2 | 11.9 | 9.7 | 15.2 | 55.8 | 4.9 | 18.9 | 1967.0 | 1435.8 | 1161.3 | 36.3 | 0.3 | 4.9 |
| RL 1 | 155.7 | 20.7 | 83.4 | 867.5 | 91.4 | 60.0 | 5.5 | 21.5 | 73.0 | 1.2 | 4.6 | 1492.1 | 1050.7 | 740.9 | 19.3 | 0.6 | 4.7 |
| RL 2 | 155.8 | 20.6 | 82.8 | 863.5 | 85.5 | 49.5 | 5.4 | 20.8 | 78.7 | 1.2 | 4.4 | 1474.5 | 1037.3 | 740.3 | 16.2 | 0.7 | 4.6 |
| RL 3 | 92.9 | 10.6 | 80.2 | 817.3 | 91.8 | 24.0 | 4.3 | 16.0 | 23.1 | 0.4 | 4.0 | 1012.0 | 971.2 | 672.6 | 6.5 | 0.4 | 3.8 |
| RL 4 | 90.0 | 10.7 | 78.1 | 790.7 | 80.8 | 23.6 | 4.3 | 15.6 | 21.8 | 0.4 | 3.8 | 907.9 | 909.9 | 652.4 | ND | 0.2 | 3.6 |
| CP 1 | 212.5 | 6.0 | 156.9 | 1237.8 | 134.1 | 6.4 | 1.6 | 7.7 | 21.2 | 9.4 | 6.7 | 2377.4 | 1385.0 | 119.6 | 43.0 | 1.1 | 5.7 |
| CP 2 | 221.3 | 7.7 | 160.5 | 1272.3 | 140.5 | 6.7 | 1.6 | 7.9 | 18.9 | 9.9 | 7.1 | 2451.9 | 1413.3 | 124.7 | 45.0 | 1.0 | 5.9 |
| CP 3 | 181.0 | 2.6 | 111.2 | 1235.2 | 145.2 | 6.9 | 1.3 | 7.3 | 55.9 | 3.1 | 6.6 | 2316.4 | 1407.8 | 127.1 | 3.9 | 1.0 | 5.6 |
| CP 4 | 176.9 | 3.4 | 98.9 | 1196.9 | 142.4 | 6.8 | 1.3 | 6.7 | 49.4 | 2.0 | 6.1 | 2043.1 | 1343.2 | 126.7 | 2.4 | 1.3 | 5.2 |

TABLE 3

| | Prebiotic carbohydrate Concentration in solution after washing mg/100 g | | | | | | | | | | | | | | | | |
|---|---|---|---|---|---|---|---|---|---|---|---|---|---|---|---|---|---|
| | | | | | | | | | | | | | Raf + | Ver + | | | Total |
| Method | Myo | Xy | Gal | Sor | Man | Rha | Ara | Xyl | Glu | Fru | Rib | Suc | Sta | Kes | Mal | Nys | (g/100 g) |
| GP 1.2 | 34.0 | 1.2 | 10.5 | 4.7 | 0.7 | 1.9 | 2.6 | 2.1 | 9.8 | 1.7 | 3.2 | 401.6 | 281.0 | 252.4 | 11.6 | 0.2 | 1.0 |
| GP 2.2 | 38.7 | 1.3 | 12.6 | 5.2 | 0.8 | 2.2 | 2.7 | 2.4 | 12.8 | 1.8 | 3.4 | 460.2 | 317.3 | 281.4 | 15.8 | 0.1 | 1.2 |
| GP 3.2 | 8.0 | 1.4 | 1.8 | 0.1 | 0.1 | ND | 1.9 | 1.8 | 22.6 | 1.1 | 3.1 | 343.7 | 228.1 | 155.6 | 15.7 | ND | 0.8 |
| GP 4.2 | 6.9 | 1.6 | 1.8 | 0.1 | 0.1 | 1.2 | 2.8 | 1.4 | 20.0 | 1.0 | 2.9 | 313.9 | 220.8 | 145.9 | 18.9 | ND | 0.7 |
| RL 1.2 | 42.6 | 0.7 | 17.1 | 228.0 | 18.8 | ND | 1.3 | 4.6 | 12.3 | 0.3 | 1.0 | 390.1 | 306.2 | 190.3 | 5.3 | ND | 1.2 |
| RL 2.2 | 49.8 | 0.6 | 18.1 | 241.0 | 19.6 | ND | 1.4 | 4.2 | 25.6 | 0.4 | 1.1 | 428.1 | 316.1 | 195.6 | 5.6 | ND | 1.3 |
| RL 3.2 | 7.3 | 3.2 | 8.5 | 113.2 | 7.8 | ND | 1.4 | 1.6 | 7.2 | 0.2 | 1.5 | 218.3 | 204.8 | 89.6 | 3.1 | ND | 0.7 |
| RL 4.2 | 6.7 | 3.2 | 8.7 | 112.5 | 7.5 | ND | 1.5 | 1.6 | 7.3 | 0.1 | 0.8 | 216.7 | 206.5 | 90.0 | 3.7 | ND | 0.7 |
| CP 1.2 | 63.9 | 0.4 | 36.3 | 322.0 | 31.1 | 1.1 | 0.4 | 1.7 | 7.0 | 0.5 | 1.7 | 608.8 | 345.3 | 28.6 | 14.8 | 0.2 | 1.5 |
| CP 2.2 | 53.3 | 0.1 | 31.8 | 292.7 | 27.1 | 1.0 | 0.3 | 1.4 | 2.2 | 0.4 | 1.6 | 545.8 | 316.6 | 24.0 | 11.9 | 0.3 | 1.3 |
| CP 3.2 | 18.8 | ND | 9.5 | 180.6 | 17.0 | 0.6 | 0.4 | 1.5 | 24.2 | 0.7 | 1.1 | 379.8 | 191.1 | 13.5 | 2.6 | 0.1 | 0.8 |
| CP 4.2 | 17.5 | ND | 9.0 | 169.7 | 16.0 | 0.5 | 0.3 | 1.6 | 20.5 | 0.6 | 1.1 | 354.5 | 181.7 | 12.7 | 2.1 | 0.1 | 0.8 |

### Example 2

### Isolation of Resistant Starch and Cellulose-Rich Prebiotic Carbohydrates (“Process 2”)

The precipitate obtained from the process described in Example 1 were further examined to isolate resistant starch and cellulose-rich prebiotic carbohydrates. After the water-soluble prebiotic carbohydrate extraction in Process 1, the residue (i.e., precipitate with water-soluble prebiotic carbohydrate removed) was mixed with 1:10 to 1:100 of pH 8-11 water by weight or volume. This solution was mixed by mechanical agitation for 2-24 hours at room temperature. The resulting solution was kept to settle into two layers of the precipitate and supernatant and then centrifuged at 2500 rpm to separate the solid precipitates from the supernatant. The liquid layer, or supernatant, was decanted. The decanted solution included the source of protein, depending on the flour type. The resulting residue (i.e., precipitate) provided a source of prebiotic carbohydrates such as resistant starch (RS), cellulose, and other polysaccharides. The isolated carbohydrate fraction had 10-50% or more prebiotic carbohydrates depending on the pulse type and variety. The resistant starch in chickpeas varied from 40% to 60%, while lentils and dry peas ranged from 20% to 50%. The remainder of the resulting residue was starch and other highly digestible polysaccharides.

FIG. 3 shows the resistant starch and cellulose-rich prebiotic carbohydrates from chickpeas, lentil, and field pea. The process of Example 2 is reflected in FIG. 4 showing the diagram of a first exemplary process 200.

### Example 3

### Isolation of Non-Digestible Starch-Free Prebiotic Polysaccharides (“Process 3”)

The precipitate obtained from the process described in Example 2 was further analyzed to isolate non-digestible starch-free prebiotic polysaccharides. After the water-soluble carbohydrate fraction was removed from Process 2, the remainder of the carbohydrate solids was subjected to alpha-amylase enzyme activity. Approximately 10-30 units of alpha-amylase and amyloglucosidase enzyme mix in one mL was added to the carbohydrate solids at a 1:10 to 1:50 (w/v) ratio. They were well mixed and kept for complete starch hydrolysis for about 10-20 hours while shaking or mechanical mixing. Upon enzyme digestion of all highly digestible starch, they were left to precipitate and washed with water and ethanol to remove all glucose resulting from starch. The resulting precipitate was dried to obtain prebiotic carbohydrates such as resistant starch, non-digestible polysaccharides, and other water-insoluble carbohydrates. The results show that an expected range of from 50 to 80% of amylose indigestible or prebiotic carbohydrates may be extracted by the above method.

FIG. 5 shows the non-digestible starch-free prebiotic carbohydrates from chickpea, lentil, and field pea. This process is reflected in FIG. 6 showing the diagram of a first exemplary process 300.

### Example 4

Total Carbohydrates after Protein Extractions (“Process 4”)

Pulse flour was mixed with a 1:10 to 1:20 (w/w) ratio of flour to water and soaked for 2 to 6 hours. The pH of the solution was adjusted to a pH of 8 to 11 and stirred by mechanical and other forms of agitation for 24-48 hours. This process enabled solubilizing of the protein in the pulse flour in an alkaline solution. Upon mixing, the solution was settled in the protein-rich supernatant and carbohydrate-rich precipitate. The solution above the precipitate layer was decanted. The residue was then dried and milled to a fine powder. The resulting powder was rich in prebiotic carbohydrates, with a percentage ranging from 60 to 90%. FIG. 7 shows the protein-free prebiotic carbohydrates from chickpea. This process is reflected in FIG. 8 showing the diagram of a first exemplary process 400.

### Example 5

### Heat Treatment on Lipoxygenase Activity

Fat-containing seeds were heat treated at various temperatures to analyze lipoxygenase activity. The samples were heat-treated at 41° C., 63° C., or 81° C. for up to 24 hours, cooled, then milled into a fine powder. A non-heat-treated sample at room temperature was also used as a comparison. Both the heat-treated and non-heat-treated samples were analyzed at day 0 versus day 30 post milling. The amount of linoleic acid (mg/100 g), linolenic acid (mg/100 g), oleic acid (mg/100 g), and stearic acid (mg/100 g) were measured as shown in Table 4 below. Linoleic acid, linolenic acid, and oleic acids are unsaturated fatty acids. Stearic acid is a saturated fatty acid that does not typically contribute to rancidity, however, was included in the analysis as a reference for analytical variation that may result from fatty acid analysis. The samples evaluated included two oat samples, and nine chickpea samples.

TABLE 4

| | | Linoleic Acid | | Linolenic Acid | | Oleic Acid | | Stearic Acid | |
|---|---|---|---|---|---|---|---|---|---|
| | | (mg/100 g) | | (mg/100 g) | | (mg/100 g) | | (mg/100 g) | |
| | Temp | Time = | Time = | Time = | Time = | Time = | Time = | Time = | Time = |
| Sample | ° C. | 0 day | 30 days | 0 day | 30 days | 0 day | 30 days | 0 day | 30 days |
| Oat 1 | Room | 502.7 | 230.8 | 241.0 | 39.0 | 373.1 | 172.8 | 49.1 | 8.1 |
| | Temp | | | | | | | | |
| Oat 1 | 41 | 735.4 | 234.9 | 233.1 | 150.8 | 249.7 | 377.0 | 56.4 | 45.0 |
| Oat 1 | 63 | 2073.4 | 470.2 | 549.5 | 126.9 | 1361.0 | 301.6 | 118.1 | 8.0 |
| Oat 1 | 81 | 1992.7 | 350.3 | 546.9 | 102.0 | 1368.4 | 221.9 | 120.0 | 24.4 |
| Oat 2 | Room | 957.8 | 286.0 | 340.1 | 93.4 | 651.4 | 189.6 | 100.6 | 27.5 |
| | Temp | | | | | | | | |
| Oat 2 | 41 | 1157.0 | 38.1 | 349.5 | 66.4 | 719.5 | 114.3 | 108.5 | 11.0 |
| Oat 2 | 63 | 1524.8 | 385.0 | 350.0 | 111.6 | 674.0 | 237.3 | 102.1 | 37.0 |
| Oat 2 | 81 | 1787.1 | 384.4 | 521.6 | 68.4 | 1188.6 | 242.5 | 188.9 | 36.1 |
| Chickpea 1 | Room | 1276.1 | 637.6 | 144.9 | 65.1 | 85.3 | 154.0 | 0.0 | 8.6 |
| | Temp | | | | | | | | |
| Chickpea 1 | 41 | 814.3 | 1236.8 | 214.8 | 173.1 | 234.1 | 262.5 | 0.0 | 15.2 |
| Chickpea 1 | 63 | 2381.2 | 585.5 | 498.7 | 96.8 | 713.5 | 135.2 | 0.0 | 8.0 |
| Chickpea 1 | 81 | 2416.9 | 33.1 | 394.7 | 34.6 | 606.9 | 26.0 | 0.0 | 0.0 |
| Chickpea 2 | Room | 1236.5 | 375.2 | 141.2 | 81.4 | 83.2 | 120.3 | 35.4 | 14.8 |
| | Temp | | | | | | | | |
| Chickpea 2 | 41 | 1277.8 | 580.7 | 301.1 | 112.3 | 420.3 | 174.9 | 55.5 | 20.6 |
| Chickpea 2 | 63 | 1354.3 | 547.5 | 322.7 | 108.2 | 440.6 | 169.8 | 55.3 | 18.1 |
| Chickpea 2 | 81 | 461.3 | 424.4 | 187.4 | 88.8 | 176.8 | 133.5 | 43.0 | 16.0 |
| Chickpea 3 | Room | 235.5 | 32.9 | 267.1 | 34.5 | 157.4 | 25.9 | 0.0 | 7.9 |
| | Temp | | | | | | | | |
| Chickpea 3 | 41 | 125.0 | 117.5 | 141.8 | 71.3 | 83.6 | 47.1 | 0.0 | 8.0 |
| Chickpea 3 | 63 | 161.3 | 77.4 | 147.2 | 54.3 | 87.5 | 37.0 | 0.0 | 7.9 |
| Chickpea 3 | 81 | 230.7 | 78.5 | 184.4 | 53.1 | 111.8 | 37.0 | 0.0 | 7.9 |
| Chickpea 4 | Room | 127.4 | 32.2 | 144.5 | 33.7 | 85.1 | 25.3 | 35.9 | 0.0 |
| | Temp | | | | | | | | |
| Chickpea 4 | 41 | 121.3 | 36.6 | 137.6 | 33.4 | 81.1 | 25.3 | 34.2 | 7.7 |
| Chickpea 4 | 63 | 265.0 | 93.1 | 202.8 | 60.8 | 125.3 | 42.7 | 39.9 | 9.2 |
| Chickpea 4 | 81 | 187.7 | 74.0 | 143.2 | 54.2 | 102.6 | 39.0 | 37.2 | 7.9 |
| Chickpea 5 | Room | 477.4 | 56.3 | 291.2 | 44.0 | 282.5 | 34.1 | 127.1 | 7.9 |
| | Temp | | | | | | | | |
| Chickpea 5 | 41 | 130.7 | 69.3 | 142.9 | 50.2 | 88.0 | 38.4 | 36.9 | 8.1 |
| Chickpea 5 | 63 | 369.7 | 239.0 | 252.6 | 124.9 | 161.3 | 90.6 | 40.4 | 8.3 |
| Chickpea 5 | 81 | 266.7 | 82.0 | 201.4 | 55.2 | 135.3 | 41.0 | 39.5 | 8.0 |
| Chickpea 6 | Room | 548.5 | 83.7 | 292.2 | 49.6 | 189.4 | 39.6 | 48.1 | 10.4 |
| | Temp | | | | | | | | |
| Chickpea 6 | 41 | 124.7 | 113.6 | 141.5 | 58.9 | 83.3 | 44.5 | 35.1 | 11.1 |
| Chickpea 6 | 63 | 277.5 | 85.4 | 207.6 | 50.3 | 153.9 | 38.6 | 51.6 | 8.1 |
| Chickpea 6 | 81 | 278.8 | 91.0 | 218.2 | 52.0 | 161.4 | 40.2 | 57.5 | 8.0 |
| Chickpea 7 | Room | 157.4 | 36.8 | 178.6 | 35.8 | 105.2 | 27.2 | 44.3 | 8.1 |
| | Temp | | | | | | | | |
| Chickpea 7 | 41 | 229.6 | 167.8 | 175.8 | 80.1 | 122.8 | 69.3 | 42.3 | 7.9 |
| Chickpea 7 | 63 | 111.1 | 60.6 | 126.1 | 44.3 | 74.4 | 35.3 | 31.3 | 10.2 |
| Chickpea 7 | 81 | 201.7 | 81.5 | 152.5 | 49.5 | 118.6 | 40.8 | 42.9 | 11.1 |
| Chickpea 8 | Room | 448.5 | 54.8 | 302.9 | 43.0 | 237.1 | 34.6 | 63.1 | 9.1 |
| | Temp | | | | | | | | |
| Chickpea 8 | 41 | 106.4 | 33.2 | 120.7 | 35.7 | 71.2 | 26.8 | 30.0 | 12.5 |
| Chickpea 8 | 63 | 276.5 | 73.9 | 209.9 | 51.0 | 152.3 | 41.1 | 46.9 | 10.4 |
| Chickpea 8 | 81 | 325.2 | 71.5 | 283.9 | 49.1 | 193.7 | 40.7 | 64.3 | 10.1 |
| Chickpea 9 | Room | 903.5 | 48.3 | 288.3 | 77.1 | 510.8 | 158.2 | 57.7 | 15.7 |
| | Temp | | | | | | | | |
| Chickpea 9 | 41 | 573.8 | 657.5 | 213.6 | 144.7 | 318.6 | 326.6 | 44.0 | 30.0 |
| Chickpea 9 | 63 | 1233.9 | 464.1 | 345.6 | 98.7 | 677.2 | 220.0 | 62.6 | 8.9 |
| Chickpea 9 | 81 | 2157.6 | 43.3 | 522.9 | 36.5 | 1117.9 | 32.1 | 131.0 | 8.1 |

As shown within the results in Table 4, for the unsaturated fatty acids, it is clearly shown that there is a reduction of the unsaturated fatty acids without heat treatment. As provided within the disclosure, it is contemplated that lipoxygenase or other fat-reducing enzymes are breaking down the fatty acids, resulting in rancidity. As shown in the results, heat treatment substantially increases the concentration of the unsaturated fatty acids. It is contemplated that the heat treatment destroys lipoxygenase enzyme, thereby reducing unsaturated fatty acid oxidation and reducing rancid substances. Beneficially, the preservation of the unsaturated fatty acids may preserve and/or extend the storage stability and quality of milled crops as provided within the disclosure.

Although the various embodiments have been described with reference to preferred implementations, persons skilled in the art will recognize that changes may be made in form and detail without departing from the spirit and scope thereof.

What is claimed is:

1. A method of isolating prebiotic carbohydrates comprising:
providing a starting material comprising a crop or source of carbohydrate and combining the starting material with water to create a first slurry; and
separating the first slurry into a first precipitate and a first supernatant component,
wherein the first supernatant component provides a source of water-soluble prebiotic carbohydrates.

2. The method of claim 1, wherein the crop or source of carbohydrate comprises pulse crops, legumes, cereals, tubers, vegetables, fruits, plants, or a combination thereof.

3. The method of claim 2, wherein the crop or source of carbohydrate comprises lentil, chickpea, field pea, cowpea, pigeon pea, faba bean, mung bean, dry bean, soybean, oats, nuts, sugar beet, corn, or a combination thereof.

4. The method of claim 1, wherein the starting material is converted to a powder having a particle size between 0.1 nm and 1 μm via a process of dry milling, wet milling, sonication, or a combination thereof, and wherein the starting material is optionally heated prior to being converted to the powder.

5. The method of claim 1, wherein the crop or source of carbohydrate is provided as a powder prior to combining with the water, and wherein the ratio of the crop or source of carbohydrate to water is in a range of about 1:2 to about 1:150 (w/w).

6. The method of claim 1, wherein the slurry is soaked and stirred for a period in the range of about 30 minutes and about 30 hours prior to the separating step.

7. The method of claim 1, wherein the separating step further comprises a step of centrifuging the slurry at a rate in the range of about 500 rpm to about 10,000 rpm for a period of time in a range of about 1 minute to about 1 hour.

8. The method of claim 1, wherein the supernatant comprises between about 0.1% and about 20% (w/w) of the water-soluble prebiotic carbohydrates.

9. The method of claim 1, further comprising a step of removing protein comprising:
combining the first precipitate with water at a ratio in a range of about 1:10 to about 1:100 to form a second slurry;
adjusting the pH of the second slurry to a range of between about 7 and about 12; and
separating the second slurry into a second precipitate and a second supernatant component,
wherein the second supernatant component contains the protein to be removed.

10. The method of claim 9, wherein the second precipitate provides a source of prebiotic carbohydrates comprising resistant starch, cellulose, other polysaccharides, or a combination thereof.

11. The method of claim 9, wherein the second precipitate comprises between about 10% and 50% more prebiotic carbohydrates than the starting material.

12. The method of claim 9, wherein the method further isolates non-digestible starch-free prebiotic carbohydrates comprising:
combining the second precipitate with water at a ratio of between about 1:10 to 1:100 to form a third slurry;
adding an enzyme;
separating the third slurry into a third precipitate and a third supernatant component,
wherein the third precipitate comprises the non-digestible starch-free prebiotic carbohydrates.

13. The method of claim 12, wherein the enzyme comprises alpha-amylase, other amylase, amyloglucosidase, or a combination thereof and is present in a range of about 1 unit per mL and about 40 units per mL.

14. The method of claim 12, wherein the third slurry and the enzyme are stirred for a period of time in the range of about 30 minutes to about 36 hours prior to the separating of the third slurry into the third precipitate and the third supernatant component.

15. The method of claim 12, wherein the third precipitate is washed with water and ethanol at least one time.

16. The method of claim 12, wherein the third precipitate comprises between about 30% to about 90% (w/w) of non-digestible starch-free prebiotic carbohydrates.

17. A method of isolating prebiotic carbohydrates comprising:
providing a starting material comprising a crop or source of carbohydrate and combining the starting material with water at a ratio in the range of about 1:10 to about 1:50 (w/v) to create a slurry;
adjusting the pH of the slurry to a range of between about 7 and about 14; and
separating the slurry into a precipitate and a supernatant component,
wherein the supernatant component comprises protein, and wherein the precipitate comprises the prebiotic carbohydrates.

18. The method of claim 17, wherein the method results in a concentration of prebiotic carbohydrates in an amount of between about 40% to about 98% by weight.

19. A method of isolating non-digestible starch-free prebiotic carbohydrates comprising:
providing a starting material comprising a crop or source of carbohydrate substantially free of both water-soluble prebiotic carbohydrates and protein;
combining the starting material with water at a ratio of between about 1:10 to 1:100 to form a slurry;
adding an enzyme;
separating the slurry into a precipitate and a supernatant component,
wherein the precipitate comprises the non-digestible starch-free prebiotic carbohydrates.

20. The method of claim 19, wherein the enzyme comprises alpha-amylase, other amylase, amyloglucosidase, or a combination thereof and is present in an amount of between about 1 unit and about 40 units per mL.

21. The method of claim 19, wherein the slurry and enzyme are stirred for a period of time in the range of about 30 minutes and about 36 hours prior to the separating of the slurry into the precipitate and the supernatant component.

22. The method of claim 19, wherein the precipitate is washed with water and ethanol at least one time.

23. The method of claim 19, wherein the precipitate comprises between about 30% to about 90% of non-digestible starch-free prebiotic carbohydrates.
